(19) United States
(12) Patent Application Publication
(10) Pub. No.: US 2012/0241141 A1
(43) Pub. Date: Sep. 27, 2012

(54) COOLING CIRCUIT WITH TRANSMISSION FLUID WARMING FUNCTION

(75) Inventor: Dwayne R. Taylor, Livonia, MI (US)

(73) Assignee: DENSO INTERNATIONAL AMERICA, INC., Southfield, MI (US)

(21) Appl. No.: 13/069,564

(22) Filed: Mar. 23, 2011

(51) Int. Cl. G05D 15/00; F28F 13/08; G05D 23/00; F28D 15/00

(52) U.S. Cl. 165/283; 165/104.19; 165/200; 165/297

(57) ABSTRACT

A cooling circuit includes a first fluid system with a radiator having an inlet portion, an outlet portion, a first heat exchanger. The first fluid system contains a first fluid and also includes a first inlet branch, a second inlet branch, and a valve member. Also, a second fluid system containing a second fluid includes a second heat exchanger that is operably coupled to the outlet portion of the radiator. The first fluid flows through the first inlet branch to be cooled by the first heat exchanger when the valve member is in the first position. The first fluid flows through the second inlet branch and bypasses the first heat exchanger to allow heat transfer between the first and second fluids via the second heat exchanger when the valve member is in the second position.

### FIELD

The present disclosure relates to a cooling circuit of a vehicle and, more particularly, relates to a cooling circuit with a transmission fluid warming function.

### BACKGROUND

This section provides background information related to the present disclosure which is not necessarily prior art.

Vehicles often include various fluid systems. For instance, cars, trucks, and other vehicles often include an engine with an associated engine cooling system. Engine coolant can flow through the engine cooling system between a cooling jacket of the engine and a radiator. As the engine coolant flows through the cooling jacket, heat generated due to fuel combustion transfers to the coolant, and the heated coolant flows to the radiator to be cooled. The coolant flows in a cycle between the cooling jacket and the radiator to keep the engine within a desired operating temperature range.

Vehicles can also include other fluid systems, such as a transmission fluid system that lubricates the gears of the transmission. In some vehicles, the transmission fluid system can include a heat exchanger that transfers heat away from the transmission fluid.

Typically, the fluid systems of a vehicle are separate and operate independent of each other. The following disclosure teaches a cooling circuit in which plural fluid systems operate in tandem for added operational efficiencies.

### SUMMARY

This section provides a general summary of the disclosure, and is not a comprehensive disclosure of its full scope or all of its features.

A cooling circuit is disclosed that includes a first fluid system through which a first fluid flows. The first fluid system includes a radiator with an inlet portion, an outlet portion, and a first heat exchanger disposed between the inlet portion and the outlet portion. The first fluid system also includes a first inlet branch that directs flow of the first fluid into the inlet portion of the radiator and a second inlet branch that directs flow of the first fluid into the outlet portion of the radiator. The first fluid system also includes a valve member having a first position and a second position. Moreover, the cooling circuit includes a second fluid system through which a second fluid flows. The second fluid system includes a second heat exchanger that is operably coupled to the outlet portion of the radiator to allow heat transfer between the first and second fluids. The first fluid flows through the first inlet branch to be cooled by the first heat exchanger when the valve member is in the first position. The first fluid flows through the second inlet branch and bypasses the first heat exchanger to allow heat transfer between the first and second fluids via the second heat exchanger when the valve member is in the second position.

A method of operating a cooling circuit is also disclosed. The method includes providing a first fluid system through which a first fluid flows, wherein the first fluid system includes a radiator with an inlet portion, an outlet portion, and a first heat exchanger disposed between the inlet portion and the outlet portion. The first fluid system also includes a first inlet branch and a second inlet branch. The method further includes providing a second fluid system through which a second fluid flows, wherein the second fluid system includes a second heat exchanger that is operably coupled to the outlet portion of the radiator to allow heat transfer between the first and second fluids. Furthermore, the method includes moving a valve member between a first position and a second position. The first position of the valve member allows the first fluid to flow through the first inlet branch into the inlet portion of the radiator to be cooled by the first heat exchanger. The second position of the valve member allows the first fluid to flow through the second inlet branch and bypass the first heat exchanger and flow into the outlet portion of the radiator to allow heat transfer between the first and second fluids via the second heat exchanger.

Still further, a vehicle is disclosed that includes an engine with a coolant jacket and a transmission system. The vehicle also includes a first fluid system through which an engine coolant flows, wherein the first fluid system includes a radiator with an inlet portion, an outlet portion, and a first heat exchanger disposed between the inlet portion and the outlet portion. The first fluid system also includes a first inlet branch that directs flow of the engine coolant from the coolant jacket into the inlet portion of the radiator. The first fluid system additionally includes a second inlet branch that bypasses the inlet portion of the radiator and the first heat exchanger and that directs flow of the engine coolant from the coolant jacket into the outlet portion of the radiator. The first fluid system further includes a valve member that has a first position and a second position. Moreover, the vehicle includes a second fluid system through which a transmission fluid flows. The second fluid system includes a second heat exchanger that is disposed within the outlet portion of the radiator to allow heat transfer between the engine coolant and the transmission fluid. The transmission fluid flows through the second fluid system between the transmission system and the second heat exchanger. The engine coolant flows through the first inlet branch to be cooled by the first heat exchanger and to receive heat from the transmission fluid when the valve member is in the first position. The engine coolant flows through the second inlet branch to bypass the first heat exchanger and to transfer heat to the transmission fluid when the valve member is in the second position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a cooling circuit with a valve member in a first position;

FIG. 2 is a schematic illustration of the cooling circuit of FIG. 1 with the valve member in the second position; and

FIG. 3 is a schematic illustration of a radiator of the cooling circuit of FIGS. 1 and 2.

Corresponding reference numerals indicate corresponding parts throughout the several views of the drawings.

### DETAILED DESCRIPTION

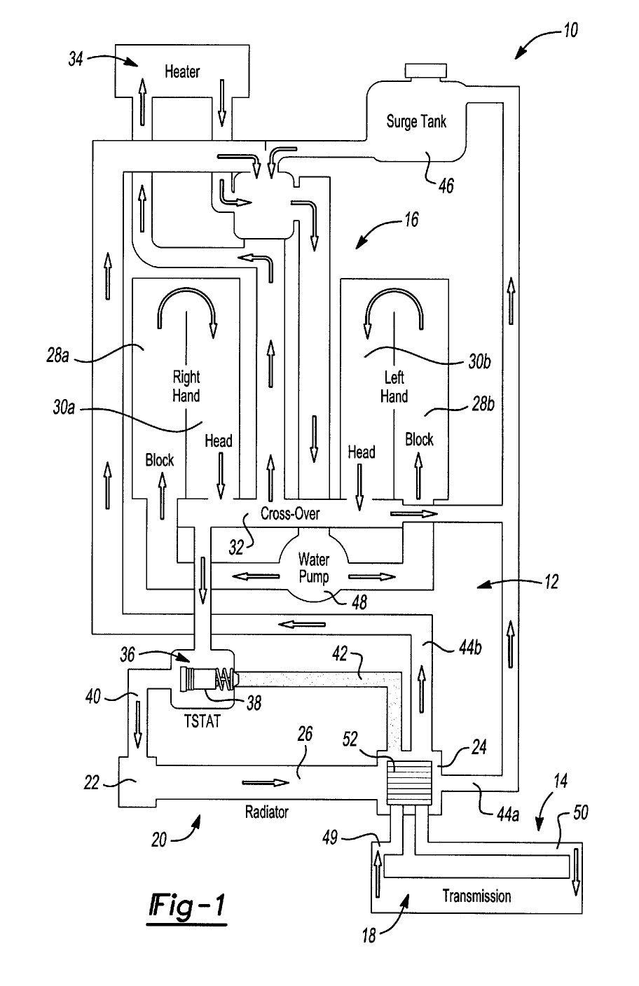

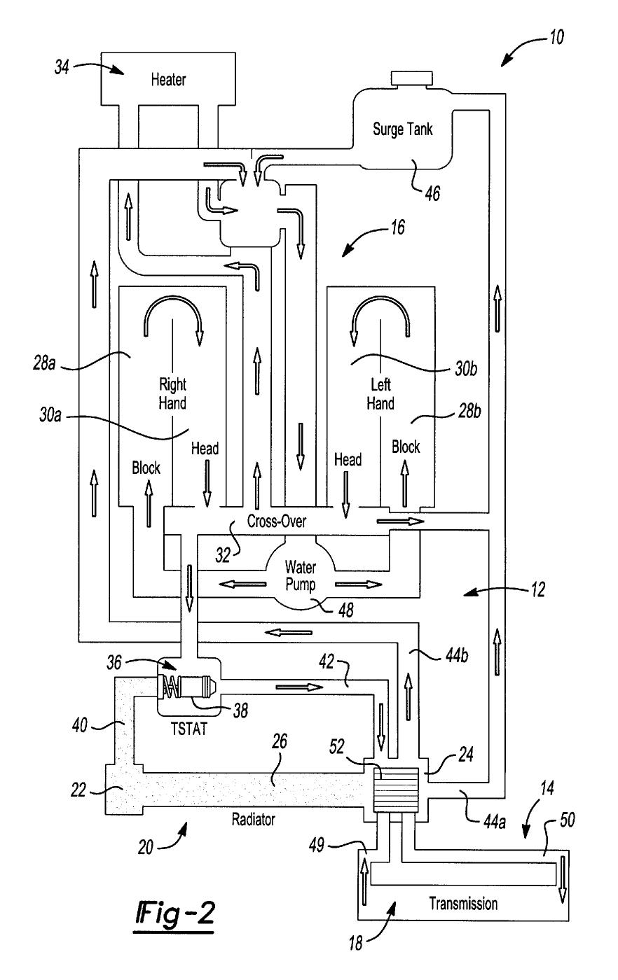

Referring initially to FIGS. 1 and 2, a cooling circuit 10 is illustrated according to various exemplary embodiments. Generally, the cooling circuit 10 can include a first fluid system 12 and a second fluid system 14. The first fluid system 12 can be associated with an engine 16, and the second fluid system 14 can be associated with a transmission system 18. As will be discussed, the first and second fluid systems 12, 14 can be operably coupled to allow heat transfer therebetween and to allow for improved operating efficiency.

The cooling circuit 10 can be incorporated into a vehicle, such as a car, truck, motorcycle, etc. The engine 16 can be a known internal combustion engine with combustion chambers, etc. The transmission system 18 can also be a known transmission system with a plurality of gears, etc.

It will be appreciated that the cooling circuit 10 can be incorporated into any machine other than a vehicle. Also, the first fluid system 12 can be associated with another component other than an engine 16, and the second fluid system 14 can be associated with another component other than a transmission system 18.

The first fluid system 12 can include a plurality of pipes, tanks, etc. (described below) through which a first fluid (e.g., engine coolant) flows. Likewise, the second fluid system 14 can include a plurality of pipes, tanks, etc. (described below) through which a second fluid (e.g., transmission fluid) flows. The first and second fluids can flow through the respective fluid systems 12, 14 to maintain the engine 16 and transmission system 18 within a desirable operating temperature range as will be discussed

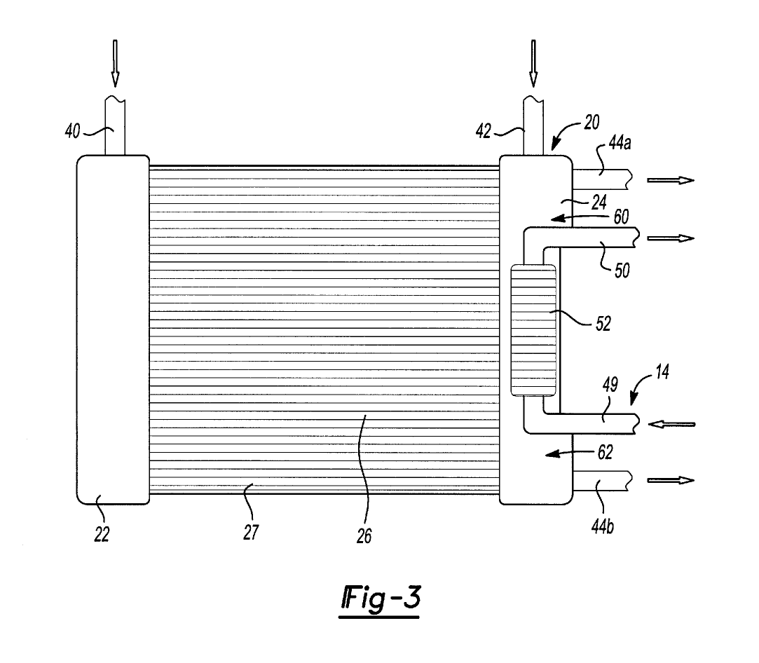

The first fluid system 12 will now be discussed in detail. The first fluid system 12 can include a radiator 20 with an inlet portion 22, an outlet portion 24, and a first heat exchanger 26 disposed between the inlet and outlet portions 22, 24 (see FIG. 3). The inlet and/or outlet portions 22, 24 can be tanks that allow the first fluid to accumulate therein for a time. The first heat exchanger 26 can include a plurality of fins 27 (FIG. 3), which provide increased surface area for increasing heat transfer rate.

The first fluid system 12 allows the first fluid to flow cyclically between the engine 16 and the radiator 20. For instance, the first fluid can flow through a right hand coolant jacket 28a and a left hand coolant jacket 28b of the engine 16 and gather heat generated within the combustion chambers of the engine 16. Then, the first fluid can flow into right and left hand heads 30a, 30b and into a cross-over passage 32. In some embodiments, some of the first fluid can flow into a heater branch 34 for providing heated air into a passenger compartment of a vehicle.

Also, downstream of the cross-over passage 32, the first fluid can flow into a valve assembly 36. The valve assembly 36 can include a valve member 38 that controls flow of the first fluid between a first inlet branch 40 and a second inlet branch 42. More specifically, the valve member 38 can have a first position (FIG. 1) in which the valve member 38 substantially seals the second inlet branch 42 to thereby allow flow of the first fluid through the first inlet branch 40 and into the inlet portion 22 of the radiator 20. The valve member 38 can also have a second position (FIG. 2) in which the valve member 38 substantially seals the first inlet branch 40 to thereby allow flow of the first fluid through the second inlet branch 42 and into the outlet portion 24 of the radiator 20. As shown in FIG. 1, when the valve member 38 is in the first position, the first fluid can flow through the inlet portion 22 of the radiator 20, through the first heat exchanger 26 to be cooled, and into the outlet portion 24 of the radiator 20. In contrast, when the valve member 38 is in the second position shown in FIG. 2, the first fluid can bypass the inlet portion 22 and first heat exchanger 26 and can flow directly into the outlet portion 24 of the radiator 20.

The valve member 38 can be a known thermostat in some embodiments. Accordingly, the valve member 38 can automatically move between its first position (FIG. 1) and its second position (FIG. 2) according to the temperature and/or pressure of the first fluid or according to any other conditions. A separate controller (not shown) can also be included for controlling the position of the valve member 38 in some embodiments. As will be discussed, the valve member 38 can be in the first position (FIG. 1) when the engine 16 is relatively warm and during normal operation of the engine 16. In contrast, the valve member 38 can be in the second position (FIG. 2) when the engine 16 is relatively cool, for instance, when the engine 16 is first started when the ambient temperature is relatively low.

The first fluid can flow out of the radiator 20 through one or more first outlet ports 44a, 44b. For instance, the first fluid can flow to a surge tank 46 through a surge first outlet port 44a, or the first fluid can flow out of the radiator 20 through a direct first outlet port 44b. In both cases, the first fluid can be pumped by a water pump 48 back toward the cooling jackets 28a, 28b of the engine 16 to begin the cycle anew.

The second fluid system 14 will now be described in detail. The second fluid system 14 can include a second inlet port 49, a second outlet port 50, and a second heat exchanger 52 disposed between the second inlet port 49 and the second outlet port 50. The second heat exchanger 52 can be operably coupled to the outlet portion 24 of the radiator 20. For instance, the second heat exchanger 52 can be disposed at least partially inside and fixed to the outlet portion 24 of the radiator 20. Moreover, the second inlet port 49 can extend into the outlet portion 24 to allow the second fluid to flow into the second heat exchanger 52, and the second outlet port 50 can extend out of the outlet portion 24 to allow the second fluid to flow out of the second heat exchanger 52 and to return back to the transmission system 18. As such, the first fluid can flow over and about the second heat exchanger 52 while the second fluid flows within and through the second heat exchanger 52 such that heat transfer can occur between the first and second fluids. The second heat exchanger 52 can also include fins (FIG. 3) that increase the exposed surface area of the second heat exchanger 52 to increase heat exchange.

As shown in FIG. 3, the outlet portion 24 of the radiator 20 can be divided into an upper section 60 and a lower section 62. The lower section 62 can be lower to the ground than the upper section 60 such that the first fluid will normally flow toward the lower section 62 due to gravity. The second inlet branch 42 can be coupled to the outlet portion 24 adjacent the upper section 60. The first outlet port 44a leading to the surge tank 46 can also be disposed adjacent the upper section 60. The first outlet port 44b leading directly to the water pump 48 can be disposed adjacent the lower section 62. Also, the second heat exchanger 52 can be fixed within the outlet portion 24 downstream of the second inlet branch 42 and upstream of the first outlet port 44b leading directly to the water pump 48. The second inlet port 49 can be disposed between the second outlet port 50 and the first outlet port 44b leading to the water pump 48. The second outlet port 50 can be disposed between the second inlet branch 42 and the second inlet port 49. Accordingly, flow of the second fluid through the second heat exchanger 52 can be substantially opposite the direction of flow of the first fluid through the outlet portion 24 of the radiator 20. In other words, as the first fluid flows substantially downward from the second inlet branch 42 to the first outlet port 44b, the second fluid flows substantially upward from the second inlet port 49, through the second heat exchanger 52, and into the second outlet port 50.

During use, assuming that the engine has been recently started and the coolant temperature of the first fluid is relatively low, the valve member 38 can be in the second position shown in FIG. 2. As such, the first fluid can flow from the engine 16 and can bypass the inlet portion 22 and first heat exchanger 26 of the radiator 20 by flowing through the second inlet branch 42, directly into the outlet portion 24 of the radiator 20. Meanwhile, the second fluid can be flowing through the second heat exchanger 52. The first fluid flowing through the outlet portion 24 of the radiator 20 is likely to be warmer than the second fluid flowing through the second heat exchanger 52; therefore, heat can transfer from the first fluid to the second fluid such that the second fluid can be warmed before flowing back to the transmission system 18. As such, the viscosity of the second fluid can be reduced, which can lead to better fuel economy. Also, because the second fluid is warmed relatively quickly, the torque converter clutch (not shown) of the transmission system 18 can lock up earlier than in other systems without the transmission fluid warming function. It will also be appreciated that because the second fluid bypasses the first heat exchanger 26, the first fluid can retain the heat gained from the engine 16 and can more efficiently transfer that heat to the second fluid.

Once the engine 16 has sufficiently warmed up, the valve member 38 can move to its first position shown in FIG. 1. As shown, the first fluid can flow through the engine 16 to gain heat therefrom, and the warmed first fluid can flow through the first inlet branch 40, into the inlet portion 22 of the radiator and through the first heat exchanger 26 to transfer the heat to air flowing past the first heat exchanger 26. Also, the second fluid can be warmer than the first fluid such that the first fluid can flow over the second heat exchanger 52 and can receive heat from the second fluid via the second heat exchanger 52 (i.e., the transmission fluid can be cooled).

Accordingly, it will be appreciated that the cooling circuit 10 can be an effective tool for heat exchange between the first and second fluids of the first and second fluid systems 12, 14. The first and second fluid systems 12, 14 can work synergistically so that the vehicle operates more efficiently.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A cooling circuit comprising:
a first fluid system through which a first fluid flows, the first fluid system including a radiator with an inlet portion, an outlet portion, and a first heat exchanger disposed between the inlet portion and the outlet portion, the first fluid system also including a first inlet branch that directs flow of the first fluid into the inlet portion of the radiator and a second inlet branch that directs flow of the first fluid into the outlet portion of the radiator, the first fluid system further including a valve member having a first position and a second position; and
a second fluid system through which a second fluid flows, the second fluid system including a second heat exchanger that is operably coupled to the outlet portion of the radiator to allow heat transfer between the first and second fluids, the first fluid flowing through the first inlet branch to be cooled by the first heat exchanger when the valve member is in the first position, the first fluid flowing through the second inlet branch and bypassing the first heat exchanger to allow heat transfer between the first and second fluids via the second heat exchanger when the valve member is in the second position.

2. The cooling circuit of claim 1, wherein heat is transferred from the second fluid to the first fluid when the valve member is in the first position, and wherein heat is transferred from the first fluid to the second fluid when the valve member is in the second position.

3. The cooling circuit of claim 1, wherein the second heat exchanger is at least partially disposed inside the outlet portion of the radiator to allow heat transfer between the first and second fluids.

4. The cooling circuit of claim 1, wherein the valve member includes a thermostat that changes between the first position and the second position according to at least one of a temperature and a pressure of the first fluid.

5. The cooling circuit of claim 1, wherein the second fluid system is in communication with a transmission system and the second fluid is a transmission fluid.

6. The cooling circuit of claim 1, wherein the first fluid system is in communication with a coolant jacket of an engine, and the first fluid is an engine coolant that transfers heat away from the engine.

7. The cooling circuit of claim 1, wherein the radiator further includes a first outlet port through which the first fluid flows out of the outlet portion of the radiator, wherein the second heat exchanger is disposed in the outlet portion of the radiator downstream of the second inlet branch and upstream of the first outlet port.

8. The cooling circuit of claim 7, wherein the second fluid system includes a second inlet port through which the second fluid flows into the second heat exchanger, wherein the second fluid system includes an second outlet port through which the second fluid flows out of the second heat exchanger, wherein the outlet portion of the radiator includes an upper section and a lower section, wherein the second inlet branch is disposed adjacent the upper section of the outlet portion, wherein the first outlet port is disposed adjacent the lower section of the outlet portion, wherein the second outlet port is disposed between the second inlet branch and the second inlet port, and wherein the second inlet port is disposed between the first outlet port and the second outlet port.

9. The cooling circuit of claim 1, wherein the first fluid system also includes a surge tank, the surge tank being in fluid communication with the outlet portion of the radiator.

10. A method of operating a cooling circuit comprising:
providing first fluid system through which a first fluid flows, the first fluid system including a radiator with an inlet portion, an outlet portion, and a first heat exchanger disposed between the inlet portion and the outlet portion, the first fluid system also including a first inlet branch and a second inlet branch;
providing a second fluid system through which a second fluid flows, the second fluid system including a second heat exchanger that is operably coupled to the outlet portion of the radiator to allow heat transfer between the first and second fluids; and
moving a valve member between a first position and a second position, the first position of the valve member allowing the first fluid to flow through the first inlet branch into the inlet portion of the radiator to be cooled by the first heat exchanger, the second position of the valve member allowing the first fluid flow through the second inlet branch and bypass the first heat exchanger and flow into the outlet portion of the radiator to allow heat transfer between the first and second fluids via the second heat exchanger.

11. The method of claim 10, further comprising transferring heat from the second fluid to the first fluid when the valve member is in the first position and transferring heat from the first fluid to the second fluid when the valve member is in the second position.

12. The method of claim 10, wherein providing the second fluid system includes providing the second heat exchanger at least partially inside the outlet portion of the radiator to allow heat transfer between the first and second fluids.

13. The method of claim 10, wherein the valve member includes a thermostat, and wherein moving the valve member includes automatically moving the valve member between the first position and the second position according to at least one of a temperature and a pressure of the first fluid.

14. The method of claim 10, further comprising flowing the second fluid through a transmission system of a vehicle.

15. The method of claim 10, further comprising flowing the first fluid out of the outlet portion of the radiator and into a surge tank.

16. The method of claim 10, further comprising flowing the first fluid through a cooling jacket of an engine to receive heat from the engine.

17. A vehicle comprising:
an engine with a coolant jacket;
a transmission system;
a first fluid system through which an engine coolant flows, the first fluid system including a radiator with an inlet portion, an outlet portion, and a first heat exchanger disposed between the inlet portion and the outlet portion, the first fluid system also including a first inlet branch that directs flow of the engine coolant from the coolant jacket into the inlet portion of the radiator, the first fluid system further including a second inlet branch that bypasses the inlet portion of the radiator and the first heat exchanger and that directs flow of the engine coolant from the coolant jacket into the outlet portion of the radiator, the first fluid system additionally including a valve member, the valve member having a first position and a second position; and
a second fluid system through which a transmission fluid flows, the second fluid system including a second heat exchanger that is disposed within the outlet portion of the radiator to allow heat transfer between the engine coolant and the transmission fluid, the transmission fluid flowing through the second fluid system between the transmission system and the second heat exchanger, the engine coolant flowing through the first inlet branch to be cooled by the first heat exchanger and to receive heat from the transmission fluid when the valve member is in the first position, the engine coolant flowing through the second inlet branch to bypass the first heat exchanger and to transfer heat to the transmission fluid when the valve member is in the second position.
